(19) United States
(12) Patent Application Publication
(10) Pub. No.: US 2017/0274340 A1
(43) Pub. Date: Sep. 28, 2017

(54) SHELL-AND-MULTI-DOUBLE CONCENTRIC-TUBE REACTOR AND HEAT EXCHANGER

(71) Applicant: KOREA INSTITUTE OF SCIENCE AND TECHNOLOGY, Seoul (KR)

(72) Inventors: Dong Ju MOON, Seoul (KR); Gi Hoon HONG, Seoul (KR); Jae Suk LEE, Seoul (KR); Jae Sun JUNG, Seoul (KR); Eun Hyeok YANG, Seoul (KR); Sung Soo LIM, Seoul (KR); Young Su NOH, Seoul (KR); Ji In PARK, Seoul (KR)

(21) Appl. No.: 15/203,604

(22) Filed: Jul. 6, 2016

(30) Foreign Application Priority Data
Mar. 24, 2016 (KR) 10-2016-0035143

(51) Int. Cl. B01J 8/06; F28F 13/06; F28D 7/02

(52) U.S. Cl. CPC B01J 8/067; F28D 7/026; F28F 13/06; F28D 2021/0022

(57) ABSTRACT

The present disclosure relates to a shell-and-multi-double concentric-tube reactor and a shell-and-multi-double concentric-tube heat exchanger, and to a shell- and-multi-double concentric-tube reactor and a shell-and-multi-double concentric-tube heat exchanger which provide a new type of reactor and a heat exchanger, thereby maximizing catalyst performance and improving performance of the reactor by optimizing heat exchange efficiency and a heat flow, uniformly distributing a reactant, and increasing a flow rate of the reactant, and accordingly making the reactor and the heat exchanger compact.

### CROSS-REFERENCE TO RELATED APPLICATION

This application claims under 35 U.S.C. §119 a the benefit of Korean Patent Application No. 10-2016-0035143 filed on Mar. 24, 2016, the entire contents of which are incorporated herein by reference.

### BACKGROUND

(a) Technical Field

The present disclosure relates to a shell-and-multi-double concentric-tube reactor and a shell-and-multi-double concentric-tube heat exchanger. More particularly, it relates to a compact shell-and-multi-double concentric-tube reactor and a compact shell-and-multi-double concentric-tube heat exchanger which are capable of efficiently obtaining a desired product through a catalytic reaction of a reactant by supplying a heating medium and the reactant, and capable of effectively controlling a reaction through a heat exchange between the reactant or a heat exchange target material and the heating medium.

(b) Background Art

In general, a shell-and-tube multitubular reactor and a shell-and-tube multitubular heat exchanger (hereinafter, referred to as a shell-and-tube reactor and a shell-and-tube heat exchanger) are a compact reactor and a compact heat exchanger which have a reactor-and-heat exchanger structure in which a shell side at which a heat exchange material is supplied is coupled to a bundle of multiple tubes in which a plurality of tubes filled with reactant gas and a catalyst are installed, and are very effective in performing catalytic reactions such as chemical reactions which generate heat or absorb a large amount of heat, particularly, a synthetic fuel producing reaction and a hydrocarbon reforming reaction.

In particular, since the shell-and-tube reactor and the shell-and-tube heat exchanger have a structure in which a bundle of tubes, which has a smaller diameter than that of the existing single-tube fixed-bed reactor and the existing single-tube heat exchanger, is applied to smoothly exchange materials and heat and maximize performance of the catalyst, the shell-and-tube reactor and the shell-and-tube heat exchanger are evaluated as being effective for a GTL (gas to liquid) process which produces synthetic petroleum from natural gas, a GTL-FPSO process which is applicable to a marine environment, a petrochemical process, a fine chemical process, and an energy environment process.

For example, because a Fischer-Tropsch synthesis reaction, which is a key reaction of the GTL process which produces synthetic petroleum from natural gas, generates a large amount of heat, and thus a smooth heat exchange is required between a catalyst layer and a heating medium in order to prevent a hot spot, the Fischer-Tropsch synthesis reaction is greatly affected by a shape of a reactor as well as a reaction condition.

In the case of the aforementioned shell-and-tube reactor, a plurality of reaction tubes is filled with a catalyst, reactant gas is supplied through inlet ports of the reaction tubes, a product and unreacted gas are discharged through discharge ports, and a heating medium circulates through a shell side so that a chemical reaction may occur under a heat exchange condition optimized by being controlled.

The reactor is useful as the Fischer-Tropsch reactor that produces liquid phase synthetic fuel by using synthetic gas made by reforming natural gas as briefly mentioned above, and the Fischer-Tropsch synthesis reaction produces long chain hydrocarbon synthetic fuel through a hydrocarbon chain propagation reaction using synthetic gas including hydrogen and carbon monoxide obtained by reforming natural gas by using reactant gas.

The Fischer-Tropsch synthesis reaction is a reaction which generates a large amount heat when synthesizing synthetic fuel, and thus it is very important to smoothly perform a heat exchange in the reactor by designing an optimal reactor as well as reaction conditions.

In addition, in the case of the GTL-FPSO process which targets a limit gas field on the sea and associated gas by applying the GTL process to a marine environment, the entire process needs to be applied to a limited space on a ship, and as a result, a compact GTL technology in which a volume thereof is greatly reduced compared to the existing

GTL process is required in consideration of the limitation to a size, a height, and a weight of an apparatus or the like, and particularly, there is an acute need for development of a GTL-FPSO technology which utilizes the compact GTL technology.

A structure of a typical shell-and-tube reactor is configured such that multitubular catalytic reaction flow paths, which are used as unit reactors and filled with a catalyst, are installed, and for example, in the case of a synthetic fuel synthetic reaction, the structure of the shell-and-tube reactor is configured such that a flow of synthetic gas for a synthetic reaction and a flow of a heating medium fluid are not mixed together, and as a result, heat of the heating medium is effectively transferred to respective unit reactors, such that reaction heat of the catalytic reaction is effectively controlled, overall operational efficiency of the reactor is improved, and the operation is easily carried out, and thus the shell-and-tube reactor is advantageous in terms of scale-up of the reaction process as well as the operation of the reaction process.

FIG. 1 illustrates a cross-sectional view of a typical shell-and-tube reactor. The shell-and tube reactor includes a catalytic reaction flow path through which a reactant flows in at an upper side of the reactor and flows out at a lower side of the reactor, and includes a separate inlet port and a separate discharge port , and a heating medium flows on a shell inner surface, thereby performing a heat exchange between heating media which flow at an outer side of the catalytic reaction flow path and on the shell inner surface.

In consideration of the aforementioned important point of the reactor and the heat exchanger, the development of a reactor, which continuously includes regions for a reaction and regions for controlling (cooling/heating) a temperature between a plurality of stages in the shell-and-tube reactor having the plurality of stages and a plurality of tubes, has been carried out.

As a related art, U.S. patent application Ser. No. 12/481,107 (hereinafter, referred to as Literature 1) discloses a shell-and-tube reactor having a plurality of stages, and includes a bundle of regions in which reactant gas flow regions and coolant flow regions are separated from each other in a longitudinal direction.

As another related art, U.S. Patent Application Publication No. 2010/260,651 (hereinafter, referred to as Literature 2) discloses a reactor including a cooling system which improves cooling efficiency by applying a double type tube, which has a vertically protruding and sealed end, to a shell type reactor including a cooling system.

However, a hot spot and a cold spot are present during a reaction which generates a large amount of heat and absorbs a large amount of heat even in the shell-and-tube reactor and the shell-and-tube heat exchanger for typical cooling/heating, and in this case, a shape of reactor, which may improve heat exchange performance of the catalyst that causes a reaction, is important.

Therefore, in order to control a change in temperature due to an exothermic reaction and an endothermic reaction which occur in the catalytic reaction flow path, a shape of reactor, which maximizes heat exchange performance by adding a shell side heating medium, allowing the heating medium to additionally flow into the catalytic reaction flow path, and performing a heat exchange inside and outside the catalytic reaction flow path, is required.

That is, there is a need for a configuration, which minimizes a difference in temperature between the reactant gas and the heat exchange target material between an inner partition wall and a central portion of the reaction flow path by minimizing a difference in temperature between the hot spot and the cold spot of the reactant gas and the heat exchange target material and by maximizing heat exchange performance.

However, Literatures 1 and 2 do not disclose a separate configuration for improving a difference in temperature between the reactant gas and the heat exchange target material, which are generated in the reaction flow path.

Therefore, the present patent is intended to present a shell-and-multi-double concentric-tube reactor and a shell-and-multi-double concentric-tube heat exchanger which maximize heat exchange performance of the shell-and-tube reactor and the shell-and-tube heat exchanger.

The above information disclosed in this Background section is only for enhancement of understanding the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art, and to provide a shell-and-multi-double concentric-tube reactor and a shell-and-multi-double concentric-tube heat exchanger which are capable of improving performance of a catalyst required for a reaction, and maximizing heat exchange efficiency to prevent a hot spot and a cold spot which are generated by an exothermic reaction and an endothermic reaction.

The present invention has also been made in an effort to provide a technology of improving heat transfer characteristics and heat exchange performance at a central portion of a reaction flow path, by including inner heating medium flow paths in order to minimize a difference in temperature between a hot spot and a cold spot of a shell-and-multi-double concentric-tube reactor and a shell-and-multi-double concentric-tube heat exchanger.

The present invention has also been made in an effort to provide a shell-and-multi-double concentric-tube reactor and a shell-and-multi-double concentric-tube heat exchanger which are capable of uniformly distributing a reactant, increasing a flow rate of the reactant, maximizing catalyst performance, improving efficiency of the reactor, and making the reactor and the heat exchanger compact.

The present invention has also been made in an effort to provide a shell-and-multi-double concentric-tube reactor and a shell-and-multi-double concentric-tube heat exchanger which are capable of being applied to various reactions by providing various heat exchange manners in the reactor by using various heat exchange media in accordance with the type of reactions.

The objects of the present invention are not limited to the aforementioned objects, and the other objects of the present invention, which are not mentioned above, may be clearly understood from the following descriptions and may become apparent from the exemplary embodiments of the present invention. In addition, the objects of the present invention may be implemented by means and a combination thereof disclosed in the claims.

In one aspect, the present invention provides a shell-and-multi-double concentric-tube reactor including: a shell side heating medium flow zone in which a shell side heating medium flows along a route formed by a baffle in a shell; a catalytic reaction zone in which a reactant gas is distributed to respective catalytic reaction flow paths by a reactant distributing unit, and the reactant gas performs a catalytic reaction with a catalyst positioned in the catalytic reaction flow paths, the catalytic reaction zone including a product capturing unit which captures a product produced by a heat exchange between the shell side heating medium and an inner heating medium and an unreacted gas which is not reacted; and an inner heating medium flow zone in which the inner heating medium is distributed to inner heating medium flow paths inserted into the catalytic reaction flow paths by an inner heating medium distributing unit, and the inner heating medium exchanges heat with the catalytic reaction flow path, and then is discharged through an inner heating medium capturing unit, in which the shell side heating medium flow zone and the catalytic reaction zone are separated by a first sealing barrier through which the catalytic reaction flow paths pass, and the catalytic reaction zone and the inner heating medium flow zone are separated by a second sealing barrier through which the inner heating medium flow paths pass so as to prevent the inner heating medium, the reactant gas, and the product from contacting one another.

In a preferred embodiment, in the shell side heating medium flow zone, the shell side heating medium may be supplied to a shell side heating medium supply port, may pass through a shell side heating medium flow path, and may exchange heat with the catalytic reaction flow path, and then the shell side heating medium may be discharged through a shell side heating medium discharge port.

In another preferred embodiment, in the catalytic reaction zone, the reactant gas may be supplied through a reactant supply port, and may pass through the catalytic reaction flow path filled with the catalyst such that a catalytic reaction between the reactant gas and the catalyst occurs, and the unreacted gas and the product produced by the reaction may be captured by the product capturing unit, and then discharged through an unreacted gas and product discharge port.

In still another preferred embodiment, in the inner heating medium flow zone, the inner heating medium may be supplied through an inner heating medium supply port, and distributed to the inner heating medium flow paths by the inner heating medium distributing unit, such that the inner heating medium exchanges heat with the catalytic reaction flow path, and then is discharged through an inner heating medium discharge port via the inner heating medium capturing unit.

In yet another preferred embodiment, an interior of the catalytic reaction flow path may be filled with a reaction catalyst in the form of an extruded pellet, a sphere, and powder.

In still yet another preferred embodiment, the catalytic reaction flow path may be configured by sequentially stacking at least one catalyst in a longitudinal direction.

In a further preferred embodiment, different heating media may be used as the shell side heating medium and the inner heating medium, respectively, or desirably the shell side heating medium and the inner heating medium may be configured by the same heating medium, but the present invention is not limited thereto.

In another further preferred embodiment, the shell side heating medium and the inner heating medium may be configured by the same heating medium.

In another aspect, the present invention provides a shell-and-multi-double concentric-tube heat exchanger including: a shell side heating medium flow zone in which a shell side heating medium flows along a route formed by a baffle in a shell; a heat exchange zone in which a heat exchange target material is distributed to respective heat exchange flow paths by a heat exchange material distributing unit, and the heat exchange target material includes a completely heat exchanged material capturing unit which captures a completely heat exchanged material produced by a heat exchange between the shell side heating medium and an inner heating medium; and an inner heating medium flow zone in which the inner heating medium is distributed to inner heating medium flow paths inserted into the heat exchange flow paths by an inner heating medium distributing unit, and the inner heating medium, which exchanges heat with the heat exchange flow paths, is discharged through an inner heating medium capturing unit, in which the shell side heating medium flow zone and the heat exchange zone are separated by a third sealing barrier through which the heat exchange flow paths pass, and the heat exchange zone and the inner heating medium flow zone are separated by a fourth sealing barrier through which the inner heating medium flow paths pass so as to prevent the inner heating medium and the heat exchange material from being in contact with each other.

In a preferred embodiment, in the shell side heating medium flow zone, the shell side heating medium may be supplied to a shell side heating medium supply port, may pass through a shell side heating medium flow path, and may exchange heat with the heat exchange flow paths, and then the shell side heating medium may be discharged through a shell side heating medium discharge port.

In another preferred embodiment, in the heat exchange zone, the heat exchange material may be supplied through a heat exchange material supply port, and may pass through the heat exchange flow paths, such that the completely heat exchanged material is captured by the completely heat exchanged material capturing unit, and then discharged through a completely heat exchanged material discharge port.

In still another preferred embodiment, in the inner heating medium flow zone, the inner heating medium may be supplied through an inner heating medium supply port, and distributed to the inner heating medium flow paths by the inner heating medium distributing unit, such that the inner heating medium exchanges heat with the heat exchange flow paths, and then is discharged through an inner heating medium discharge port via the inner heating medium capturing unit.

In yet another preferred embodiment, different heating media may be used as the shell side heating medium and the inner heating medium, or the shell side heating medium and the inner heating medium may be configured by the same heating medium, and at least one heating medium selected from water, working oil, and solvent may be used.

In still yet another preferred embodiment, the reactant gas or the heat exchange medium, which is supplied to the reactor and the heat exchanger, may be supplied in a counter flow method or a co-current flow method, but the present invention is not limited to the supply manners.

The present invention may obtain the following effects through combinations of the aforementioned present exemplary embodiments and configurations to be described below.

It is possible to easily adjust heat exchange performance of the reactor and the heat exchanger to a desired level by changing heat exchange areas and lengths by adjusting inner diameters of tubes of the shell side heating medium flow path, the reaction flow path, and the inner heating medium flow path.

In addition, it is possible to adjust a temperature of a catalyst unit through which reactant gas flows and a temperature of the heat exchange flow path by using the heating medium in the flow path at the shell side, and it is possible to adjust a temperature of the catalyst unit through which reactant gas flows by using the inner heating medium flow path, thereby easily ensuring thermal stability of a catalyst layer produced by the catalytic reaction of the reactant gas by the effective heat exchange between the reactant gas and the heat exchange target material.

Furthermore, it is possible to uniformly distribute the reactant or the heat exchange target material, increase a flow rate of the reactant or the heat exchange target material, maximize catalyst performance, and improve efficiency of the reactor and the heat exchanger, thereby greatly reducing sizes of the reactor and the heat exchanger.

In addition, the reducing of sizes of the reactor and the heat exchanger contributes to simplification and downsizing of XTL processes (GTL, CTL, BTL) for producing clean fuel, GTL-FPSO manufacturing processes, petrochemical processes, fine chemical processes, compact reforming devices for a fuel cell, hydrogen stations, energy processes and the like.

Other aspects and preferred embodiments of the invention are discussed infra.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles, e.g, fuel derived from resources other than petroleum. As referred to herein, a hybrid vehicle is a vehicle that has two or more sources of power, for example, both gasoline-powered and electric-powered vehicles.

The above and other features of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 illustrates a cross-sectional side view of a shell-and-tube reactor in the related art;

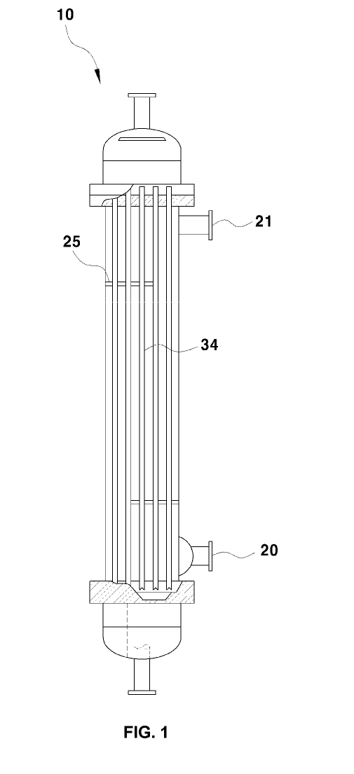

FIG. 2 illustrates a cross-sectional side view of a configuration of a shell-and-multi-double concentric-tube reactor according to an exemplary embodiment of the present invention;

FIG. 3 illustrates a transverse cross-sectional view of the shell-and-multi-double concentric-tube reactor according to the exemplary embodiment of the present invention;

FIG. 4 illustrates a perspective view of a single flow path of the shell-and-multi-double concentric-tube reactor according to the exemplary embodiment of the present invention;

FIG. 5A illustrates a graph illustrating a temperature difference of a catalytic reaction flow path in longitudinal direction in the related art, which is a Comparative Example with respect to the present invention;

FIG. 5B illustrates a graph illustrating a temperature difference of a catalytic reaction flow path in a longitudinal direction of the shell-and-multi-double concentric-tube reactor according to the exemplary embodiment of the present invention;

FIG. 6 illustrates a cross-sectional side view of a shell-and-multi-double concentric-tube heat exchanger according to the exemplary embodiment of the present invention; and

FIG. 7 illustrates a perspective view of a configuration of a single flow path of the shell-and-multi-double concentric-tube heat exchanger according to the exemplary embodiment of the present invention.

Reference numerals set forth in the Drawings include reference to the following elements as further discussed below:

10: reactor

20: shell side heating medium supply port

21: shell side heating medium discharge port

24: shell side heating medium flow path

25: baffle

30: reactant supply port

31: product discharge port

32: reactant distributing unit

33: product capturing unit

34: catalytic reaction flow path

40: inner heating medium supply port

41: inner heating medium discharge port

42: inner heating medium distributing unit

43: inner heating medium capturing unit

44: inner heating medium flow path

50: upper first sealing barrier

51: uppermost second sealing barrier

60: lower first sealing barrier

61: lowermost second sealing barrier

100: heat exchanger

120: shell side heating medium supply port

121: shell side heating medium discharge port

124: shell side heating medium flow path

125: baffle

130: heat exchange material supply port

131: completely heat exchanged material discharge port

132: heat exchange material distributing unit

133: completely heat exchanged material capturing unit

134: heat exchange flow path

140: inner heating medium supply port

141: inner heating medium discharge port

142: inner heating medium distributing unit

143: inner heating medium capturing unit

144: inner heating medium flow path

150: upper third sealing barrier

151: uppermost fourth sealing barrier

160: lower third sealing barrier

161: lowermost fourth sealing barrier

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in more detail with reference to the accompanying drawings. The exemplary embodiments of the present invention may be modified in various forms, and the scope of the present invention should not be interpreted as being limited to the following exemplary embodiments. The present exemplary embodiments are provided to more completely explain the present invention to a person with ordinary skill in the art.

The term “unit”, “port”, or the like, which is described in the specification, means a unit that performs at least one function or operation.

In the present specification, names of constituent elements are classified as a first. . . , a second . . . , and the like so as to discriminate the constituent elements having the same name, and the names are not essentially limited to the order in the description below.

The present invention relates to a compact reactor 10 and a compact heat exchanger 100 to which a concept of a shell-and-multi-double concentric-tube is applied to solve the aforementioned problems in the related art. The present invention relates to the compact reactor 10 and the heat exchanger 100 which may be usefully applied to XTL (GTL, CTL, BTL, etc.) fields such as clean synthetic fuel producing processes, chemical reaction fields required for petrochemical industries, environmental equipment fields, offshore plant fields such as a GTL-FPSO, MeOH-FPSO, DME-FPSO, and cooling and heating systems to which the heat exchanger 100 is applied.

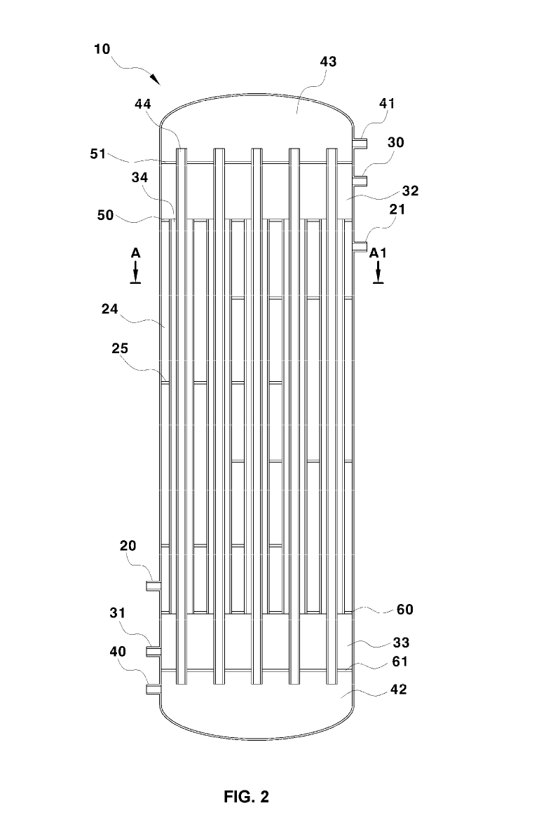

FIG. 2 is a cross-sectional side view illustrating a configuration of the shell-and-multi-double concentric-tube reactor 10 according to the exemplary embodiment of the present invention. As illustrated in FIG. 2, the reactor 10 according to the present invention includes heating medium flow paths through which a heating medium flows to a shell side, catalytic reaction unit flow paths which are filled with a catalyst and through which a reactant flows, and flow paths through which an inner heating medium flows, and in this case, the respective flow paths are configured such that the heating medium, the reactant, and the catalyst are not in contact with one another, and the respective flow paths may be made of metal so as to ensure a sufficient heat exchange. Catalytic reaction flow paths 34, through which the reactant flows, and inner heating medium flow paths 44 may be made of metal, and more particularly, include all materials that do not perform a chemical reaction with a shell side heating medium.

In the exemplary embodiment of the present invention, aluminum or copper which has excellent thermal conductivity and machinability, or stainless steel, or nickel or cobalt based alloys (inconel, monel, etc.), which has excellent heat resistance and corrosion resistance, may be used as materials of the flow paths that constitute the reactor 10, in order to ensure excellent heat exchange performance and durability and easily form the flow paths through which a fluid may flow, but the material of the flow paths is not limited to the aforementioned materials.

Since the present invention provides the shell-and-tube reactor 10 that maintains a vertical shape, the reactor 10 includes a configuration in which the shell side heating medium flows in from a shell side heating medium supply port 20 to the shell side of the reactor 10, and the shell side heating medium, which has exchanged heat, is discharged through the shell side heating medium discharge port 21. More particularly, in the exemplary embodiment of the present invention, the shell side heating medium supply port 20 may be positioned at a lower end of the reactor 10, and the shell side heating medium discharge port 21 may be positioned at an upper end of the reactor 10, and the reactor 10 further includes baffles 25 which are positioned on a shell inner surface and constitute the routes of the shell side heating medium movement.

As described above, the shell side heating medium according to the present invention flows in through the shell side heating medium supply port 20 and is discharged through the shell side heating medium discharge port 21 via flow routes formed by the baffles 25 positioned on the shell inner surface, and as a result, it is possible to form shell side heating medium flow paths 24 including a maximum cross-sectional area of catalytic reaction flow paths 34 positioned in the shell.

As described above, the shell side heating medium, which flows in through the shell side heating medium supply port 20, exchanges heat in a shell side heating medium flow zone which circulates in the shell. The shell side heating medium flow zone, which is configured as described above, is separated by first sealing barriers 50 and 60 respectively positioned at the upper and lower ends of the reactor 10, and with the first sealing barriers 50 and 60, the shell side heating medium discharge port 21 and a reactant distributing unit 32 are separated from the shell side heating medium supply port 20 and a product capturing unit 33. As described above, the reactor 10 includes the shell side heating medium flow zone positioned in an interior where the first sealing barriers 50 and 60, which are respectively positioned at the upper and lower ends of the reactor 10, face each other.

The reactor 10 according to the present invention includes a plurality of catalytic reaction flow paths 34 which is positioned in the shell and through which the reactant gas passes. The catalytic reaction flow paths 34 may be filled with a catalyst in a longitudinal direction of the flow paths. More particularly, the catalysts, which perform different functions, may be configured to be sequentially stacked in the longitudinal direction of the catalytic reaction flow paths 34, and the amount of catalyst and the number of a single reactor may vary depending on an aspect or the purpose of the reactor 10 used by a user. In addition, the interior of the catalytic reaction flow paths 34 may be filled with at least one reaction catalyst in the form of an extruded pellet, a sphere, and powder.

In addition, instead of a fixed-bed reactor, a slurry bubble column reactor may be provided. In the slurry bubble column reactor, liquid in which a catalyst in the form of powder is mixed with a liquid-state solvent, and reactant gas are simultaneously supplied.

In the case of the catalytic reaction flow paths 34, the reactant is distributed through the reactant distributing unit 32 to the catalytic reaction flow paths 34 filled with the catalyst. The reactant distributing unit 32 is fluidly connected with the reactant supply port 30 positioned on the shell side surface, such that a heat exchange target reactant flows into the reactant distributing unit 32. The distributed reactant passes through the catalytic reaction flow paths 34 in the longitudinal direction, and performs a contact reaction with at least one catalyst accommodated in the catalytic reaction flow paths 34. A product produced by the reactant, which performs the catalytic reaction as described above, and an unreacted material, which does not perform a reaction, are captured by the product capturing unit 33 positioned at the lower end of the reactor 10. The captured product or unreacted material may be discharged to the outside of the shell through a product discharge port 31 connected with the product capturing unit 33.

The product capturing unit 33, which is configured as described above, is positioned at the lower end of the reactor 10, and sealed and separated between a lower first sealing barrier 60 and a lowermost second sealing barrier 61 which are positioned at the lower end of the reactor 10. Furthermore, the reactant distributing unit 32 is positioned, sealed and separated between an uppermost second sealing barrier 51, and an upper first sealing barrier 50, thereby forming a single catalytic reaction zone positioned between upper and lower portions of the reactor 10 including the catalytic reaction flow paths 34. The catalytic reaction zone includes the catalytic reaction flow paths 34 and is configured in the interior where the first sealing barriers 50 and 60 and the second sealing barriers 51 and 61, which are respectively positioned at the upper and lower ends, face each other, and the catalytic reaction zone may be positioned at a middle portion of the reactor 10 according to the present invention.

The catalytic reaction flow path 34 is configured to have an annular shape, and include the inner heating medium flow paths 44 positioned in the catalytic reaction flow paths 34. The exemplary embodiment of the present invention includes the catalytic reaction flow path 34 having an annular shape, and the inner heating medium flow path 44 has a smaller diameter than the catalytic reaction flow path 34. The inner heating medium flow path 44, which is configured as described above, has the same center as the catalytic reaction flow path 34, and includes portions which protrude from the upper and lower ends of the catalytic reaction flow path 34 and are connected to an upper end of the reactant distributing unit 32 and a lower end of the product capturing unit 33, respectively.

The inner heating medium flow path 44 is supplied with the heating medium from an inner heating medium supply port 40, and the heating medium, which has exchanged heat in the catalytic reaction flow paths 34, is discharged through an inner heating medium discharge unit while penetrating the catalytic reaction flow paths 34. More particularly, the heating medium, which is supplied through the inner heating medium supply port 40, flows into the inner heating medium distributing unit 42 positioned at a lowermost end of the reactor 10, and the heating medium positioned in the inner heating medium distributing unit 42 flows into the respective inner heating medium flow paths 44. The heating medium, which flows into the respective inner heating medium flow paths 44 as described above, may be captured by the inner heating medium capturing unit 43 positioned at an uppermost end of the reactor 10, and then may be discharged through an inner heating medium discharge port 41 positioned at a shell side end.

The shell side heating medium may be configured by the same heating medium as the inner heating medium, but the present invention is not limited thereto.

As described above, the heating medium, which flows in through the inner heating medium flow paths 44 positioned in the catalytic reaction flow paths, exchanges heat with the catalytic reaction flow path, and the inner heating medium distributing unit 42, which is positioned at one opened end of the inner heating medium flow path 44 and configured at the lowermost end of the reactor 10, and the inner heating medium capturing unit 43, which is positioned at the uppermost end of the reactor 10, are sealed by the second sealing barriers 51 and 61 and both upper and lower ends of the reactor 10, respectively. As described above, the present invention forms the inner heating medium flow zone that includes all of the configurations for allowing a flow of the inner heating medium, and the inner heating medium flow zone is sealed by the inner heating medium distributing unit 42, the inner heating medium capturing unit 43, and the second sealing barriers 51 and 61 respectively positioned at the upper and lower ends of the reactor 10. The uppermost second sealing barrier 51 is positioned between the inner heating medium capturing unit 43 and the reactant distributing unit 32 so as to prevent the reactant and the inner heating medium from being mixed together, and the lowermost second sealing barrier 61 is positioned between the inner heating medium distributing unit 42 and the product capturing unit 33 so as to prevent the product and the inner heating medium from being mixed together. As described above, the heating medium, which flows inside the inner heating medium flow zone, is separated from the reactant, the product and the like not to contact the reactant, the product and the like.

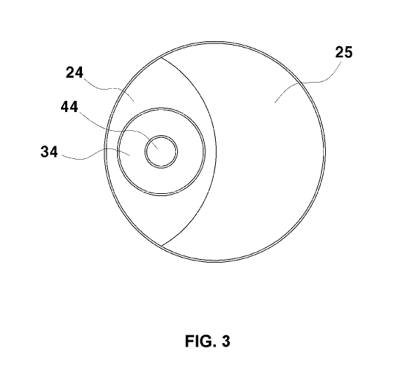

FIG. 3 is a cross-sectional view illustrating a configuration of the shell-and-multi-double concentric-tube reactor 10 according to the exemplary embodiment of the present invention.

The cross-sectional view illustrates a cross section taken along line A-A′ in FIG. 2, and illustrates the catalytic reaction flow path 34, the inner heating medium flow path 44, and the shell side heating medium flow path 24.

The annular catalytic reaction flow path 34 according to the present invention further includes the inner heating medium flow path 44 which is positioned in the catalytic reaction flow path 34 having a circular shape and has the same center as the catalytic reaction flow path 34. The inner heating medium flow path 44 exchanges heat with the reactant close to a central portion of the catalytic reaction flow path 34, and may cool the reactant gas positioned on an inner wall surface of the catalytic reaction flow path 34.

In the exemplary embodiment of the present invention, inner diameters of the catalytic reaction flow path 34 and the inner heating medium flow path 44 of the reactor 10 may be 10.0 to 150.0 mm, and 10.0 to 50.0 mm, respectively, and more particularly, may be 5.0 to 50.0 mm, and 5.0 to 25.0 mm, respectively.

The reactor 10 according to the present invention may be generally applied to a configuration that performs an exothermic reaction or an endothermic reaction, and more particularly, the reactor 10 according to the present invention may be applied to a reactor of GTL, GTL-FPSO (floating production storage and offloading), DME-FPSO, and MeOH-FPSO for producing clean fuel such as GTL (gas-to-liquid), CTL (coal-to-liquid), BTL (biomass-to-liquid), DME (dimethyl ether), and MeOH (methanol), a fuel reforming device for a fuel cell, a hydrogen station, a petrochemical process, a fine chemical process, and environmental and energy processes.

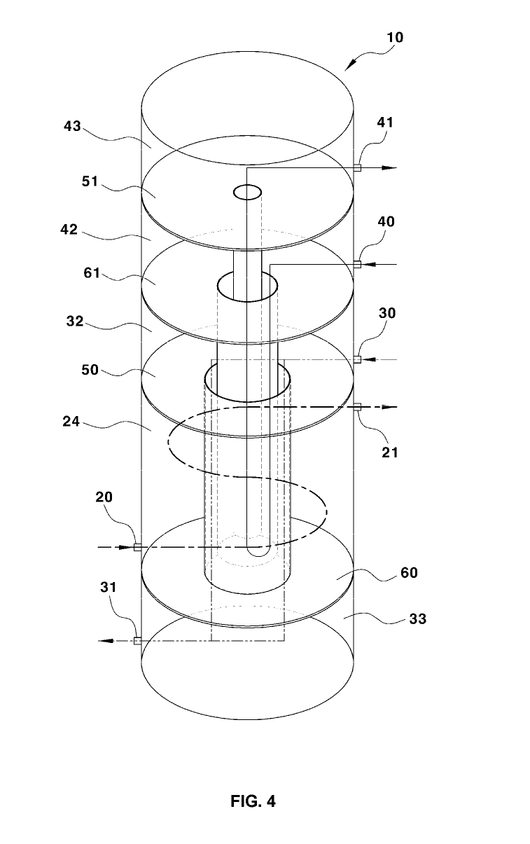

FIG. 4 illustrates a single flow path of the shell-and-multi-double concentric-tube reactor 10 according to the exemplary embodiment of the present invention.

The reactor 10 includes the catalytic reaction zone positioned between the second sealing barriers 51 and 61 and the first sealing barriers 50 and 60 which are positioned between upper and lower sides of the catalytic reaction flow path 34 and the reactor 10, such that the reactant may flow into the respective catalytic reaction flow paths 34 through the reactant distributing unit 32 positioned at the upper end of the reactor 10. Furthermore, the product, which is produced by the catalytic reaction caused by contact with the catalyst in the catalytic reaction flow paths 34, or the unreacted reactant is captured by the product capturing unit 33 positioned at the lower end of the reactor, such that the catalytic reaction zone may be configured to be sealed.

The reactor may include a shell side heating medium flow zone including a sealed zone in an interior where the first sealing barriers 50 and 60 face each other. The shell side heating medium flow zone includes the shell side heating medium supply port 20 and the shell side heating medium discharge port 21 which are positioned inside the first sealing barriers 50 and 60, and includes at least one baffle 25 positioned on the shell inner surface.

The exemplary embodiment of the present invention provides a configuration in which the shell side heating medium flows in through the shell side heating medium supply port 20 positioned at an upper end of the lower end first sealing barrier 60, and the introduced shell side heating medium is discharged through the shell side heating medium discharge port 21 positioned at a lower end of the upper end first sealing barrier 50. The reactor includes the shell side heating medium flow zone as described above, such that the heating medium flow route of the heating medium is configured depending on the number and the shape of the baffle 25 positioned in the shell side heating medium flow zone.

The reactor 10 according to the present invention further includes the inner heating medium capturing unit 43 positioned at the upper end of the uppermost second sealing barrier 51, and the inner heating medium distributing unit 42 positioned at the lower end of the lowermost second sealing barrier 61. The inner heating medium flows into the inner heating medium distributing unit 42, which is positioned at the lower end of the lowermost second sealing barrier 61, through the inner heating medium supply port 40, and the introduced inner heating medium may flow into the inner heating medium capturing unit 43, which is positioned at the uppermost end of the reactor 10, through the inner heating medium flow path 44. The inner heating medium, which is captured by the inner heating medium capturing unit 43 as described above, may be discharged to the outside of the shell reactor 10 through the inner heating medium discharge port 41 connected with the inner heating medium capturing unit 43. The inner heating medium flow zone is configured as described above, such that the inner heating medium is supplied into the inner heating medium flow path 44 positioned in the catalytic reaction flow path 34, and exchanges heat with the central portion of the catalytic reaction flow path 34.

As a result, the reactor 10 according to the present invention is provided as a reactor 10 with a shell-and-multi-double concentric-tube concept, in which the heating medium flow paths, through which the shell side heating medium flows, are formed by the baffle 25 in the shell, the catalytic reaction flow paths 34 which are filled with the catalyst and through which the heat exchange reactant flows are configured in the reactor 10, and the inner heating medium flow paths 44 through which the inner heating medium passes are inserted into the catalytic reaction flow paths 34, thereby improving heat exchange performance by exchanging heat using a dual structure in addition to a simple shell-and-tube concept in the related art.

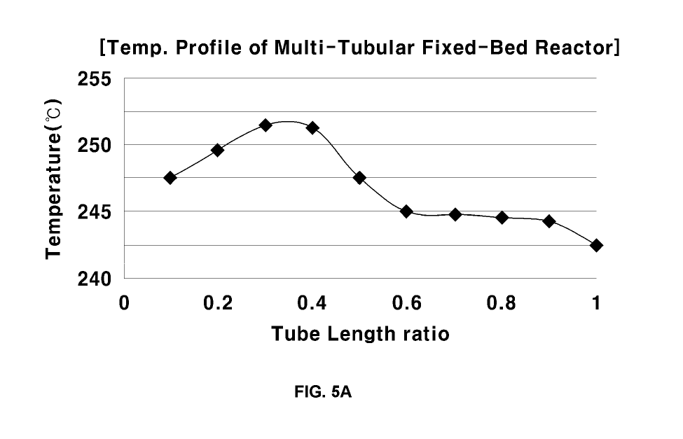

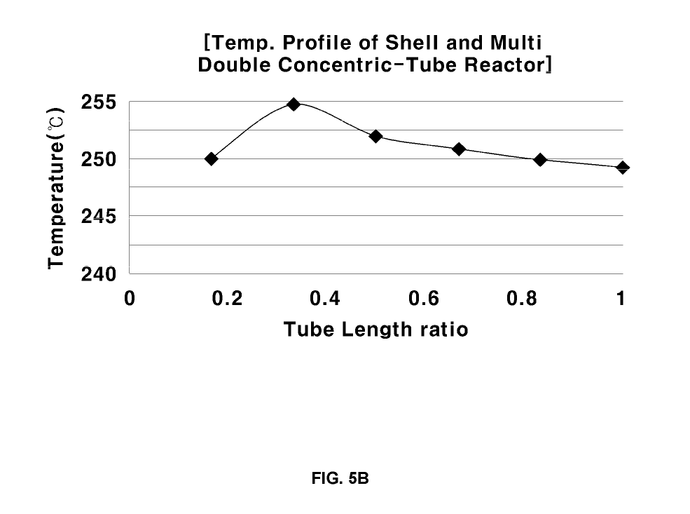

FIG. 5A illustrates a graph illustrating a difference in temperature of the reactant gas in the longitudinal direction of the catalytic reaction flow path 34 of the shell-and-tube reactor 10 in the related art.

That is, FIG. 5A illustrates a difference in temperature, ΔT=9K, of the reactant gas in the longitudinal direction of the catalytic reaction flow path 34 in a case in which a GTL-FPSO (floating production storage and offloading) exothermic reaction is carried out by the shell-and-tube reactor 10 including the catalytic reaction flow path 34 having an inner diameter of 20 mm in the related art.

In comparison with FIG. 5A, FIG. 5B illustrates a graph according to measurement of a temperature of the reactant gas in the longitudinal direction of the reactor 10 including the annular catalytic reaction flow path 34 according to the exemplary embodiment of the present invention.

In accordance with the exemplary embodiment of the present invention, the reactor 10 is configured according to a GTL-FPSO (floating production storage and offloading) exothermic reaction, in which inner diameters of the catalytic reaction flow path 34 and the inner heating medium flow path 44 are 20 mm and 10 mm, respectively.

The reactor 10 according to the present invention, which is configured as described above, includes the catalytic reaction flow path 34 which is configured in the longitudinal direction in the shell, such that the reactant gas flows in through the reactant distributing unit 32 at the upper end of the reactor 10, and then flows into the catalytic reaction flow path 34. As described above, the reactant gas comes into contact with the catalyst in the catalytic reaction flow path 34, and moves in the longitudinal direction such that an exothermic reaction of the reactant gas is carried out.

In the exemplary embodiment of the present invention which is configured as described above, a difference in temperature, which occurs in the longitudinal direction of the catalytic reaction flow path 34 by an FTS reaction, which is an exothermic reaction during a GTL-FPSO (floating production storage and offloading) process, is ΔT=5.4K, and it could be seen that it is very easy to control a temperature in the longitudinal direction of the reactor 10, and it is also easy to adjust selectivity of reaction products in accordance with the adjustment of the temperature in comparison with a difference in temperature in the longitudinal direction of the catalytic reaction flow path 34 in the related art.

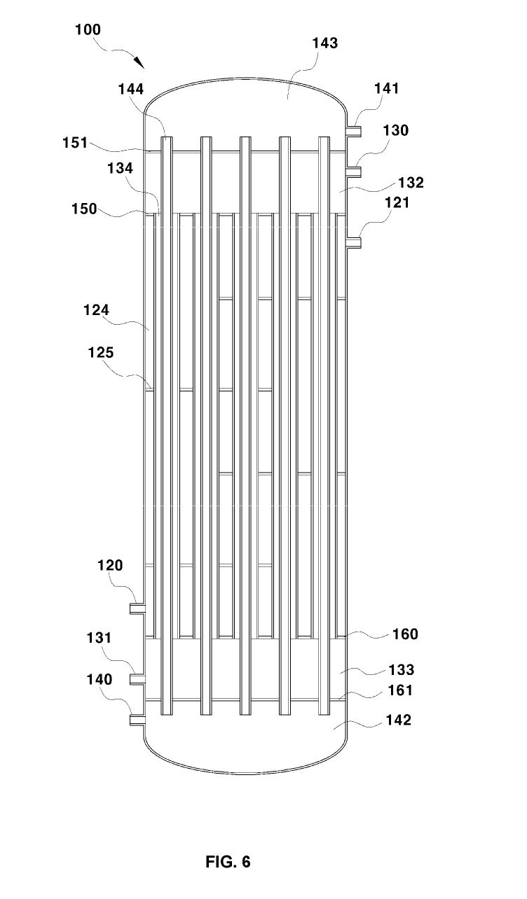

FIG. 6 is a cross-sectional side view illustrating a configuration of the shell-and-multi-double concentric-tube heat exchanger 100 according to the exemplary embodiment of the present invention. As illustrated, the heat exchanger 100 according to the present invention includes heating medium flow paths through which a heating medium flows to a shell side, heat exchange flow paths 134, and flow paths through which an inner heating medium flows, and in this case, the heating media in the respective flow paths and the heat exchange flow paths 134 are not exchanged, and the respective flow paths may be made of metal so as to ensure a sufficient heat exchange. Furthermore, the heat exchange flow paths 134 may be made of metal, and more particularly, include all materials that do not perform a chemical reaction with a shell side heating medium.

In the exemplary embodiment of the present invention, aluminum or copper which has excellent thermal conductivity and machinability, or stainless steel, nickel or cobalt based alloys (inconel, monel, etc.), which has excellent heat resistance and corrosion resistance, may be used as materials of the flow paths that constitute the heat exchanger 100, in order to ensure excellent heat exchange performance and durability and easily form the flow path through which a fluid may flow, but the material of the flow path is not limited to the aforementioned materials.

Since the present invention provides the shell-and-tube heat exchanger 100 that maintains a vertical shape, the heat exchanger includes a configuration in which the shell side heating medium flows from a shell side heating medium supply port 120 into the shell of the heat exchanger 100, and the shell side heating medium, which has exchanged heat, is discharged through a shell side heating medium discharge port 121. More particularly, in the exemplary embodiment of the present invention, the shell side heating medium supply port 120 may be positioned at a lower end of the heat exchanger 100, and the shell side heating medium discharge port 121 may be positioned at an upper end of the heat exchanger 100, and the heat exchanger 100 further includes baffles 125 which are positioned on a shell inner surface and constitute the routes of the shell side heating medium movement. As described above, the shell side heating medium flow path 124 is configured with the baffles 125.

As described above, the shell side heating medium according to the present invention flows in through the shell side heating medium supply port 120 and is discharged through the shell side heating medium discharge port 121 via flow routes formed by the baffles 125 positioned on the shell inner surface, and as a result, the shell side heating medium may pass through the entire region of the area of the heat exchange flow paths 134 positioned in the shell.

As described above, the shell side heating medium, which flows in through the shell side supply port, exchanges heat in a shell side heating medium flow zone which circulates in the shell. The shell side heating medium flow zone, which is configured as described above, is separated by third sealing barriers 150 and 160 respectively positioned at upper and lower ends of the heat exchanger 100, such that the upper end third sealing barrier 150 is positioned between the shell side heating medium discharge port 121 and a heat exchange material distributing unit 132, and the lower end third sealing barrier 160 is positioned between the shell side heating medium supply port 120 and a completely heat exchanged material capturing unit 133. As described above, the heat exchanger includes the shell side heating medium flow zone positioned in an interior where the third sealing barriers 150 and 160 respectively positioned at the upper and lower ends face each other.

The heat exchanger 100 according to the present invention includes the heat exchange flow paths 134 positioned in the shell. The heat exchange flow paths 134 are connected with the heat exchange material distributing unit 132 such that the heat exchange target material flows into the heat exchange flow paths 134, and the heat exchange flow paths 134 are connected with the completely heat exchanged material capturing unit 133 and capture a completely heat exchanged material. Furthermore, the heat exchange material distributing unit 132 may be connected with a heat exchange material supply port 130 positioned outside the heat exchanger 100, and the completely heat exchanged material capturing unit 133 may be connected with a completely heat exchanged material discharge port 131 positioned outside the heat exchanger 100.

The completely heat exchanged material capturing unit 133, which is configured as described above, is positioned at the lower end of the heat exchanger 100, and sealed with and separated from an inner heating medium distributing unit 142 by a lowermost fourth sealing barrier 161. Furthermore, an inner heating medium capturing unit 143 positioned at an upper end of the heat exchange material distributing unit 132 is sealed with and separated from the heat exchange material distributing unit 132 by an uppermost fourth sealing barrier 151, thereby forming a single heat exchange zone positioned between upper and lower sides of the heat exchange flow path 134 and the heat exchanger 100. The heat exchange zone is configured in the interior where the third sealing barriers 150 and 160 and the fourth sealing barriers 151 and 161, which are positioned at the upper and lower ends of the heat exchanger 100, face each other, and thus the heat exchange zone may be positioned at a middle portion of the heat exchanger 100 according to the present invention.

The heat exchange flow path 134 is configured to have an annular shape, and includes an inner heating medium flow path 144 positioned in the heat exchange flow path 134. The exemplary embodiment of the present invention includes the heat exchange flow path 134 having an annular shape, and the inner heating medium flow path 144 has a smaller diameter than the heat exchange flow path 134. The inner heating medium flow path 144, which is configured as described above, has the same central portion as the heat exchange flow path 134, and includes portions which protrude at upper and lower ends thereof, and penetrate an upper end of the heat exchange material distributing unit 132 and a lower end of the completely heat exchanged material capturing unit 133.

The inner heating medium flow path 144 is supplied with the heating medium from the inner heating medium supply port (heat exchange flow path 134), and the heating medium, which has exchanged heat in the heat exchange flow paths 134, is discharged through an inner heating medium discharge unit while penetrating the heat exchange flow paths 134. More particularly, the heating medium, which is supplied through the inner heating medium supply port (heat exchange flow paths 134), flows into the inner heating medium distributing unit 142 positioned at a lowermost end of the heat exchanger 100, and the heating medium positioned in the inner heating medium distributing unit 142 flows into the respective inner heating medium flow paths 144. The heating medium, which flows into the respective inner heating medium flow paths 144 as described above, may be captured by the inner heating medium capturing unit 143 positioned at an uppermost end of the heat exchanger 100, and then may be discharged through an inner heating medium discharge port 141 positioned at a shell side end.

As described above, the heating medium, which flows in through the inner heating medium flow paths 144 positioned in the heat exchange flow paths 134, exchanges heat with the heat exchange flow paths 134, and the inner heating medium distributing unit 142, which is positioned at one opened end of the inner heating medium flow path 144 and positioned at the lowermost end of the heat exchanger 100, and the inner heating medium capturing unit 143, which is positioned at the uppermost end of the heat exchanger 100, are sealed by the fourth sealing barriers 151 and 161 and both upper and lower ends of the heat exchanger 100, respectively. As described above, the present invention forms the inner heating medium flow zone that includes all of the configurations for allowing a flow of the inner heating medium, and the inner heating medium flow zone is sealed by the fourth sealing barriers 151 and 161 which are positioned at the inner heating medium capturing unit 143 and the inner heating medium distributing unit 142 , respectively. As described above, the heating medium, which flows inside the inner heating medium flow zone, is separated not to contact the heat exchange material, the completely heat exchanged material and the like.

The annular heat exchange flow path 134 according to the present invention further includes the inner heating medium flow path 144 which is positioned in the heat exchange flow path 134 having a circular shape and has the same center as the heat exchange flow path 134. The inner heating medium flow path 144 exchanges heat with the heat exchange material close to the central portion of the heat exchange flow path 134, and may cool the heat exchange material that is difficult to exchange heat with an inner wall surface of the heat exchange flow path 134 which abuts the shell side heating medium.

In the exemplary embodiment of the present invention, inner diameters of the heat exchange flow path 134 and the inner heating medium flow path 144 of the heat exchanger 100 may be 10.0 to 150.0 mm, and 10.0 to 50.0 mm, respectively, and more particularly, may be 5.0 to 50.0 mm, and 5.0 to 25.0 mm, respectively.

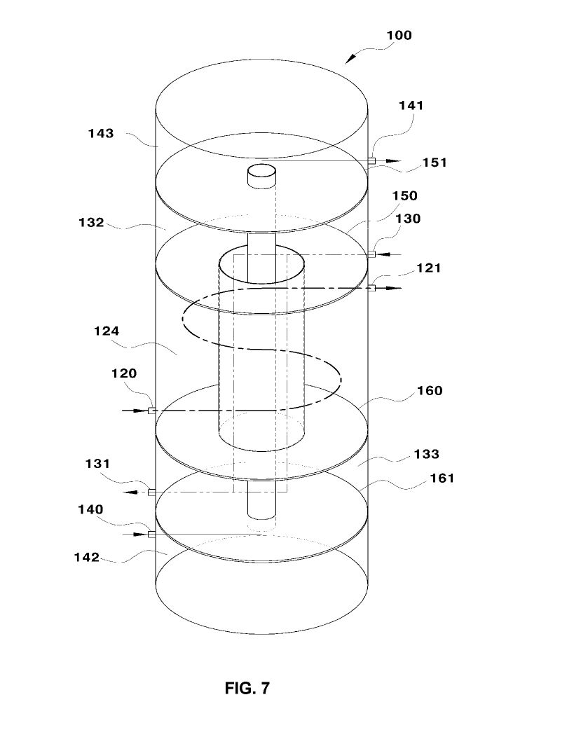

FIG. 7 illustrates a configuration of a single heat exchange flow path 134 of the shell-and-multi-double concentric-tube heat exchanger 100 according to the exemplary embodiment of the present invention.

The heat exchanger 100 includes the heat exchange zone positioned between the third sealing barriers 150 and 160 and the fourth sealing barriers 151 and 161 which are positioned at the upper and lower sides of the heat exchanger 100 , such that the heat exchange material may flow into the respective heat exchange flow paths 134 through the heat exchange material distributing unit 132 positioned at the upper end of the heat exchanger 100. Furthermore, the heat exchange material, which has completely exchanged heat in the heat exchange flow paths 134, is captured by the completely heat exchanged material capturing unit 133 positioned at the lower end of the heat exchanger 100, and a space in which the heat exchange material is captured may be configured to be sealed.

The heat exchanger 100 may include a shell side heating medium flow zone as a sealed zone in an interior where the third sealing barriers 150 and 160 face each other at the upper and lower sides of the heat exchanger 100. The shell side heating medium flow zone includes the shell side heating medium supply port 120 and the shell side heating medium discharge port 121 which are positioned inside the third sealing barriers 150 and 160, and includes at least one baffle 125 positioned on the shell inner surface.

The exemplary embodiment of the present invention provides a configuration in which the shell side heating medium flows in through the shell side heating medium supply port 120 positioned at an upper end of the lower end third sealing barrier 160, and the introduced shell side heating medium is discharged through the shell side heating medium discharge port 121 positioned at a lower end of the upper end third sealing barrier 150. The heat exchanger includes the shell side heating medium flow zone as described above, such that the heating medium flow route of the heating medium is configured depending on the number and the shape of the baffle 125 positioned in the shell side heating medium flow zone.

The heat exchanger 100 according to the present invention further includes the inner heating medium capturing unit 143 positioned at the upper end of the uppermost fourth sealing barrier 151, and the inner heating medium distributing unit 142 positioned at the lower end of the lowermost fourth sealing barrier 161. The inner heating medium flows into the inner heating medium distributing unit 142, which is positioned at the lower end of the lowermost fourth sealing barrier 161, through the inner heating medium supply port (heat exchange flow paths 134), and the introduced inner heating medium may flow into the inner heating medium capturing unit 143, which is positioned at the uppermost end of the heat exchanger 100, through the inner heating medium flow path 144. The inner heating medium, which is captured by the inner heating medium capturing unit 143 as described above, may be discharged to the outside of the shell heat exchanger 100 through the inner heating medium discharge port 141 connected with the inner heating medium capturing unit 143. The inner heating medium flow zone is configured as described above, such that the inner heating medium is supplied into the inner heating medium flow path 144 positioned in the heat exchange flow path 134, and exchanges heat with the central portion of the heat exchange target material.

As a result, the heat exchanger 100 according to the present invention is provided as a heat exchanger 100 with a shell-and-multi-double concentric-tube concept, in which the heating medium flow paths, through which the shell side heating medium flows, are formed by the baffle 125 in the shell, and the inner heating medium flow paths 144 through which the inner heating medium passes are inserted into the heat exchange flow paths 134, thereby improving heat exchange performance by exchanging heat using a dual structure instead of a simple shell-and-tube concept in the related art.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A shell-and-multi-double concentric-tube reactor comprising:
a shell side heating medium flow zone in which a shell side heating medium flows along a route formed by a baffle in a shell;
a catalytic reaction zone in which a reactant is distributed to respective catalytic reaction flow paths by a reactant distributing unit, and the reactant performs a catalytic reaction with a catalyst positioned in the catalytic reaction flow paths, the catalytic reaction zone including a product capturing unit which captures a product produced by a heat exchange between the shell side heating medium and an inner heating medium and an unreacted material which is not reacted; and
an inner heating medium flow zone in which the inner heating medium is distributed to inner heating medium flow paths inserted into the catalytic reaction flow paths by an inner heating medium distributing unit, and the inner heating medium, which exchanges heat with the catalytic reaction flow path, is discharged through an inner heating medium capturing unit,
wherein the shell side heating medium flow zone and the catalytic reaction zone are separated by a first sealing barrier through which the catalytic reaction flow paths pass, and
the catalytic reaction zone and the inner heating medium flow zone are separated by a second sealing barrier through which the inner heating medium flow paths pass so as to prevent the inner heating medium, the reactant, and the product from being in contact with one another.

2. The shell-and-multi-double concentric-tube reactor of claim 1, wherein in the shell side heating medium flow zone, the shell side heating medium is supplied to a shell side heating medium supply port, passes through a shell side heating medium flow path, and exchanges heat with the catalytic reaction flow path, and then the shell side heating medium is discharged through a shell side heating medium discharge port.

3. The shell-and-multi-double concentric-tube reactor of claim 1, wherein in the catalytic reaction zone, the reactant is supplied through a reactant supply port, is distributed to the catalytic reaction flow paths filled with the catalyst by the reactant distributing unit, and then passes through the catalytic reaction flow paths such that a catalytic reaction between the reactant and the catalyst occurs, and the unreacted material and the product produced by the reaction are captured by the product capturing unit, and then discharged through an unreacted material and product discharge port.

4. The shell-and-multi-double concentric-tube reactor of claim 1, wherein in the inner heating medium flow zone, the inner heating medium is supplied through an inner heating medium supply port, and distributed to the inner heating medium flow paths by the inner heating medium distributing unit, such that the inner heating medium exchanges heat with the catalytic reaction flow path, and then is discharged through an inner heating medium discharge port via the inner heating medium capturing unit.

5. The shell-and-multi-double concentric-tube reactor of claim 3, wherein an interior of the catalytic reaction flow path is filled with a reaction catalyst in the form of an extruded pellet, a sphere, and powder.

6. The shell-and-multi-double concentric-tube reactor of claim 1, wherein the catalytic reaction flow path is configured by sequentially stacking at least one catalyst in a longitudinal direction.

7. The shell-and-multi-double concentric-tube reactor of claim 1, wherein the shell side heating medium and the inner heating medium are configured by the same heating medium or different heating media, and one or more heating media selected from water, working fluid, and solvent is used as the heating media.

8. The shell-and-multi-double concentric-tube reactor of claim 1, wherein a counter flow method and a co-current flow method are applicable depending on a supply method of the reactor, and the supply method is not limited thereto.

9. The shell-and-multi-double concentric-tube reactor of claim 1, wherein, the reactor is the type of a fixed-bed reactor or a slurry bubble column reactor which is provided depending on a method to fill the catalytic reaction flow paths with the catalyst and a method to provide reactant gas, and the type of a reactor is not limited thereto.

10. A shell-and-multi-double concentric-tube heat exchanger comprising:
a shell side heating medium flow zone in which a shell side heating medium flows along a route formed by a baffle in a shell;
a heat exchange zone in which a heat exchange target material is distributed to respective heat exchange flow paths by a heat exchange material distributing unit, and a completely heat exchanged material capturing unit capturing a completely heat exchanged material produced by heat exchange between the heat exchange target material and the shell side heating medium and an inner heating medium, is included; and
an inner heating medium flow zone in which the inner heating medium is distributed to inner heating medium flow paths inserted into the heat exchange flow paths by an inner heating medium distributing unit, and the inner heating medium, which exchanges heat with the heat exchange flow paths, is discharged through an inner heating medium capturing unit,
wherein the shell side heating medium flow zone and the heat exchange zone are separated by a third sealing barrier through which the heat exchange flow paths pass, and
the heat exchange zone and the inner heating medium flow zone are separated by a fourth sealing barrier through which the inner heating medium flow paths pass so as to prevent the inner heating medium and the heat exchange material from being in contact with each other.

11. The shell-and-multi-double concentric-tube heat exchanger of claim 10, wherein in the shell side heating medium flow zone, the shell side heating medium is supplied to a shell side heating medium supply port, passes through a shell side heating medium flow path, and exchanges heat with the heat exchange flow paths, and then the shell side heating medium is discharged through a shell side heating medium discharge port.

12. The shell-and-multi-double concentric-tube heat exchanger of claim 10, wherein in the heat exchange zone, the heat exchange material is supplied through a heat exchange material supply port, is distributed to the heat exchange flow paths by the heat exchange material distributing unit, and then passes through the heat exchange flow paths, such that the completely heat exchanged material produced by a heat exchange is captured by the completely heat exchanged material capturing unit, and then discharged through a completely heat exchanged material discharge port.

13. The shell-and-multi-double concentric-tube heat exchanger of claim 10, wherein in the inner heating medium flow zone, the inner heating medium is supplied through an inner heating medium supply port, and distributed to the inner heating medium flow paths by the inner heating medium distributing unit, such that the inner heating medium exchanges heat with the heat exchange flow paths, and then is discharged through an inner heating medium discharge port via the inner heating medium capturing unit.

14. The shell-and-multi-double concentric-tube heat exchanger of claim 10, wherein the shell side heating medium and the inner heating medium are configured by the same heating medium.

15. The shell-and-multi-double concentric-tube heat exchanger of claim 10, a counter flow method and a co-current flow method are applicable depending on a supply method of the heat exchanger, and the heat exchanger is not limited to the supply methods.
